(19) United States
(12) Patent Application Publication
(10) Pub. No.: US 2019/0245947 A1
(43) Pub. Date: Aug. 8, 2019

(54) COMMUNICATION DEVICE, COMMUNICATION METHOD, PROGRAM, AND COMMUNICATION SYSTEM

(71) Applicant: SONY SEMICONDUCTOR SOLUTIONS CORPORATION, KANAGAWA (JP)

(72) Inventor: MICHITO ISHII, KANAGAWA (JP)

(21) Appl. No.: 16/336,315

(22) PCT Filed: Jul. 21, 2017
(86) PCT No.: PCT/JP2017/026542

§ 371 Date: Mar. 25, 2019

(30) Foreign Application Priority Data
Oct. 31, 2016 (JP) 2016-213057

(51) Int. Cl. H04L 29/06; H04L 29/08

(52) U.S. Cl. CPC H04L 69/03; H04B 13/005; H04L 67/12; H04L 69/18

(57) ABSTRACT

[Object] To ease complexity for users in protocol selection. [Solution] A communication device including: a receiving unit that receives two or more pieces of protocol information, each of which indicates a protocol, from another communication device; a selecting unit that selects a protocol on the basis of priority set for protocol selection from protocols common to two or more protocols usable by the communication device and two or more protocols indicated by the two or more pieces of protocol information; and a communication control unit that controls communication with the other communication device according to the protocol selected by the selecting unit.

### TECHNICAL FIELD

The present invention relates to a communication device, a communication method, a program, and a communication system.

### BACKGROUND ART

As communication protocols to enable communication among plurality of communication devices, variety of protocols, such as object exchange (OBEX), small computer system interface (SCSI), and internet protocol (IP), have been known. A communication device can communicate with another communication device by using a common protocol with the other communication device.

In a case in which plurality of communication devices have two or more common protocols, for example, a protocol selected from two or more common protocols is used for communication among the plurality of communication devices. Patent Literature 1 discloses a technique in which a communication device acquires a list of protocols usable by another communication device, and the communication device selects a protocol on the basis of data type (for example, photographic data, music data, and the like) that is selected as an object to be communicated by a user in a case in which two or more protocols usable by both the communication device and the other communication device are present.

### CITATION LIST

### Patent Literature

Patent Literature 1: JP 2011-114708A

### DISCLOSURE OF INVENTION

### Technical Problem

However, with the technique described in Patent Literature 1, it has been difficult to select a protocol appropriately without a data type selecting operation by users.

Therefore, the present disclosure proposes a novel and improved communication device, communication method, program, and communication system that enable to ease complexity for users in protocol selection.

### Solution to Problem

According to the present disclosure, there is provided a communication device including: a receiving unit that receives two or more pieces of protocol information, each of which indicates a protocol, from another communication device; a selecting unit that selects a protocol on the basis of priority set for protocol selection from protocols common to two or more protocols usable by the communication device and two or more protocols indicated by the two or more pieces of protocol information; and a communication control unit that controls communication with the other communication device according to the protocol selected by the selecting unit. According to the configuration, it is possible to implement protocol selection on the basis of priority in a case in which plurality of protocols are common to two communication devices.

In addition, according to the present disclosure, there is provided a communication device including: a transmitting unit that transmits two or more pieces of protocol information, each of which indicates a protocol, to another communication device; a receiving unit that receives selected protocol information indicating a protocol that has been selected from two or more protocols indicated by the two or more pieces of protocol information on the basis of priority set for protocol selection from the other communication device; and a communication control unit that controls communication with the other communication device according to the protocol indicated by the selected protocol information received by the receiving unit.

In addition, according to the present disclosure, there is provided a communication method including: receiving, by a communication device, two or more pieces of protocol information, each of which indicates a protocol, from another communication device; selecting, by a processor, a protocol on the basis of priority set for protocol selection from protocols common to two or more protocols usable by the communication device and two or more protocols indicated by the two or more pieces of protocol information; and controlling communication with the other communication device according to the selected protocol.

In addition, according to the present disclosure, there is provided a communication method including: transmitting, by a communication device, two or more pieces of protocol information, each of which indicates a protocol, to another communication device; receiving selected protocol information indicating a protocol that has been selected from two or more protocols indicated by the two or more pieces of protocol information on the basis of priority set for protocol selection from the other communication device; and controlling, by a processor, communication with the other communication device according to the protocol indicated by the received selected protocol information.

In addition, according to the present disclosure, there is provided a program that causes a computer to function as a communication device including: a receiving unit that receives two or more pieces of protocol information, each of which indicates a protocol, from another communication device; a selecting unit that selects a protocol on the basis of priority set for protocol selection from protocols common to two or more protocols usable by the communication device and two or more protocols indicated by the two or more pieces of protocol information; and a communication control unit that controls communication with the other communication device according to the protocol selected by the selecting unit.

In addition, according to the present disclosure, there is provided a program that causes a computer to function as: a transmitting unit that transmits two or more pieces of protocol information, each of which indicates a protocol, to another communication device; a receiving unit that receives selected protocol information indicating a protocol that has been selected from two or more protocols indicated by the two or more pieces of protocol information on the basis of priority set for protocol selection from the other communication device; and a communication control unit that controls communication with the other communication device according to the protocol indicated by the selected protocol information received by the receiving unit.

In addition, according to the present disclosure, there is provided a communication system including: a first communication device that transmits two or more pieces of protocol information, each of which indicates a protocol; and a second communication device. The second communication device includes a receiving unit that receives the two or more pieces of protocol information from the first communication device, a selecting unit that selects a protocol on the basis of priority set for protocol selection from protocols common to two or more protocols usable by the first communication device and two or more protocols indicated by the two or more pieces of protocol information, and a communication control unit that controls communication with the first communication device according to the protocol selected by the selecting unit.

### Advantageous Effects of Invention

As described above, according to the present disclosure, it is possible to ease complexity for users in protocol selection. Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is an explanatory diagram illustrated to describe a configuration of a human-body communication system.

FIG. 2 is an explanatory diagram illustrated to describe an example of a hierarchical structure of communication in the human-body communication system.

FIG. 3 is a block diagram illustrated to describe a configuration of a sensor terminal according to an embodiment of the present disclosure.

FIG. 4 is an explanatory diagram illustrated to describe an overall configuration of a data packet.

FIG. 5 is an explanatory diagram illustrated to describe a configuration of payload of a negotiation packet.

FIG. 6 is an explanatory diagram illustrated to describe a specific example of values that can be set to each field.

FIG. 7 is an explanatory diagram illustrated to describe a specific example of a protocol list.

FIG. 8 is an explanatory diagram illustrated to describe a configuration example of a reconfirm packet.

FIG. 9 is a block diagram illustrated to describe a configuration of a mobile terminal according to an embodiment of the present disclosure.

FIG. 10 is an explanatory diagram illustrated to describe a specific example of a listener-side protocol list.

FIG. 11 is a flowchart illustrated to describe an action of a sensor terminal according to an embodiment of the present disclosure.

FIG. 12 is a flowchart illustrated to describe an action of a mobile terminal according to an embodiment of the present disclosure.

FIG. 13 is an explanatory diagram illustrated to describe a communication sequence between the sensor terminal and the mobile terminal according to an embodiment of the present disclosure.

FIG. 14 is an explanatory diagram illustrated to describe a protocol list according to a modification.

FIG. 15 is an explanatory diagram illustrated to describe a hardware configuration of a mobile terminal.

FIG. 16 is an explanatory diagram illustrated to describe another configuration example of a protocol list.

FIG. 17 is an explanatory diagram illustrated to describe a specific example of protocol selection.

### MODE(S) FOR CARRYING OUT THE INVENTION

Hereinafter, preferred embodiments of the present disclosure will be described in detail with reference to the appended drawings. Note that in this specification and the appended drawings, structural elements that have substantially the same function and structure are denoted with the same reference numerals, and repeated explanation of these structural elements is omitted.

Also, in this specification and the appended drawings, plurality of structural elements having substantially the same function and structure may in some cases be distinguished by different letters appended to the same sign. For example, plurality of elements having substantially the same function and structure or logical significance are distinguished as sensor terminals 10A and 10B and so on as necessary. On the other hand, in a case of not particularly distinguishing each of plurality of structural elements having substantially the same function and structure, only the same sign will be given to each of the plurality of structural elements. For example, in a case of not particularly distinguishing the sensor terminals 10A and 10B, each client will be designated simply the sensor terminal 10.

Moreover, the present disclosure will be described in the following order of items.

1. Overview of human body communication system
2. Configuration of sensor terminal
3. Configuration of mobile terminal

### 4. Action

### 5. Modification

6. Hardware configuration

### 7. Conclusion

### 1. OVERVIEW OF HUMAN-BODY COMMUNICATION SYSTEM

Embodiments of the present disclosure are applicable to variety of communication systems. As an example, an embodiment of the present disclosure is applied to a human-body communication system that is also called body area network (BAN).

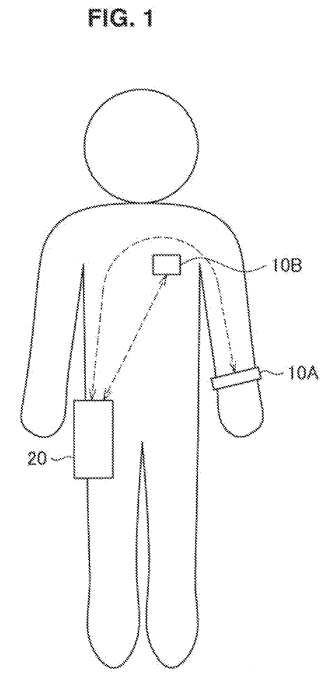

The human-body communication system is a system that incorporates a human body as a transmission medium for signals, and includes plurality of terminals positioned adjacent to a human body, such as an interior and a surface of a body. Uses of the human-body communication system includes, for example, monitoring health conditions of a user, monitoring sleep conditions of a user, monitoring kinetic conditions of a user, and the like. For the above monitoring, a sensor terminal that has sensors, such as a pulse sensor, an accelerometer sensor, an angular velocity sensor, and an electrocardiogram sensor, can be used as a terminal constituting the human-body communication system. Moreover, the human-body communication system can be applied to various other uses, such as unlock of a door by contact of a user holding a terminal and a door knob, and payment by contact of a user holding a terminal and a settlement terminal. Hereinafter, a specific configuration example of such a human-body communication system will be described with reference to FIG. 1.

FIG. 1 is an explanatory diagram illustrated to describe a configuration of the human-body communication system. FIG. 1 illustrates a human-body communication system that includes a sensor terminal 10A, a sensor terminal 10B, and a mobile terminal 20.

The sensor terminal 10A is a wristband type communication device, and detects pulses of a user. The sensor terminal 10A transmits detection information of pulses to the mobile terminal 20 through a body of the user.

The sensor terminal 10B is a communication device that is worn on a chest of the user, and detects electrocardiographic conditions of the user. The sensor terminal 10B transmits detection information of electrocardiographic conditions to the mobile terminal 20 through the body of the user.

The mobile terminal 20 is a communication device carried by the user. The mobile terminal 20 is connected to the sensor terminal 10A or the sensor terminal 10B through the body of the user, and receives detection information from the sensor terminal 10A or the sensor terminal 10B. An application installed on the mobile terminal 20 is capable of providing various services to the user by using the received detection information. For example, the application of the mobile terminal 20 may generate a display page to show chronological changes in the detection information, and may output an alarm in a case in which the detection information indicates an abnormal value.

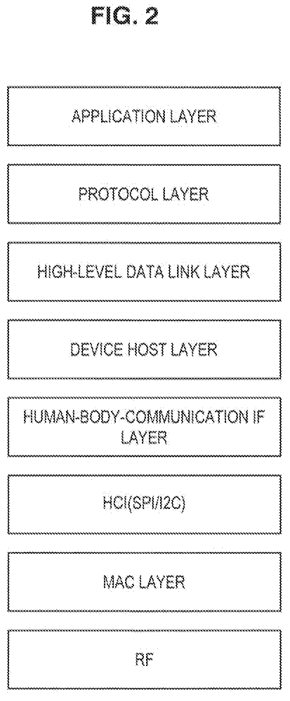

An example of a hierarchical structure of communication in the human-body communication system is described herein with reference to FIG. 2. As illustrated in FIG. 2, the hierarchical structure of communication in the human-body communication system can include a radio frequency (RF), a media access control (MAC) layer, a host controller interface (HOI) (SPI/I2C), a human-body-communication interface (IF) layer, a device host layer, a high-level data link layer, a protocol layer, and an application layer.

The RF, the MAC layer, the HCI SPI/I2C), and the human-body-communication IF layer broadly correspond to a physical layer and a data link layer of an OSI reference model, and the device host layer and the high-level data link layer broadly correspond to a data link layer and a network layer in the OSI reference model. Furthermore, the protocol layer broadly corresponds to a network layer, a transport layer, a session layer, and a presentation layer in the OSI reference model, and the application layer corresponds to an application layer in the OSI reference model.

Note that in the human-body communication system, a connection mode of communication devices can be limited to one-to-one due to constraints of RF. Moreover, a MAC address of a communication device can be dynamically changed. Therefore, to identify a party on the other end of communication, exchange of address with guaranteed uniqueness, such as UUID, is performed at a higher level layer than the MAC layer.

As described above, plurality of units of the sensor terminals 10 can be put on the body of the user, and the mobile terminal 20 can find plurality of sensor terminals by search processing also called discover. However, it is conceivable that protocols usable by the respective sensor terminals 10 differ from each other. Furthermore, it is also conceivable that the single sensor terminal 10 or the mobile terminal 20 can use plurality of protocols. Therefore, in the communication between the mobile terminal 20 and the sensor terminal 10, a mechanism for selecting an appropriate protocol according to a party on the other end of communication is needed.

Therefore, an embodiment of the present disclosure has been achieved focusing on the above situations. According to an embodiment of the present disclosure, it is possible to select an appropriate protocol while easing complexity for users. Hereinafter, configurations and actions of the such sensor terminals 10 and mobile terminal 20 according to an embodiment of the present disclosure will be sequentially described in detail.

### 2. CONFIGURATION OF SENSOR TERMINAL

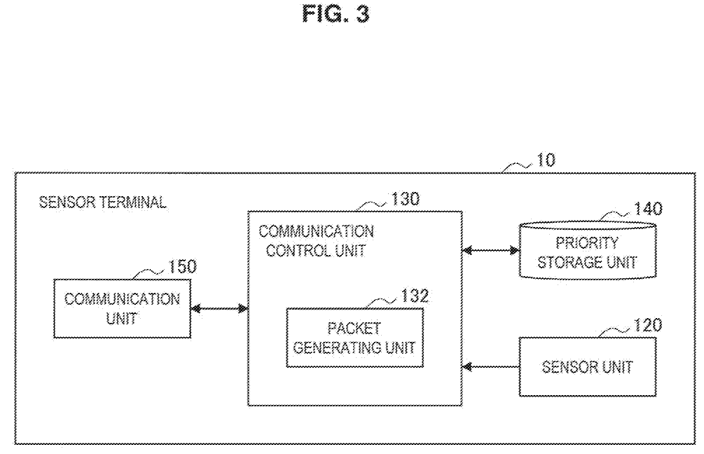

FIG. 3 is a block diagram illustrated to describe a configuration of the sensor terminal 10 according to the embodiment of the present disclosure. As illustrated in FIG. 3, the sensor terminal 10 according to the embodiment of the present disclosure includes a sensor unit 120, a communication control unit 130, a priority storage unit 140, and a communication unit 150.

### (Sensor Unit)

The sensor unit 120 includes one, or two or more sensors. For example, the sensor unit 120 may include a global positioning system (GPS) sensor, an accelerometer sensor, a gyro sensor, a temperature sensor, a barometric sensor, a sound pressure sensor, a pulse sensor, and electrocardiogram sensor, and the like.

### (Communication Control Unit, Priority Storage Unit)

The communication control unit 130 controls overall communication by the sensor terminal 10. Particularly, in the communication control unit 130 according to the present embodiment, a function to determine a protocol used for communication with the mobile terminal 20 after connection of the device host layer with the mobile terminal 20 is established is implemented as a high-level data link layer. Part of the function is implemented by a packet generating unit 132 illustrated in FIG. 3.

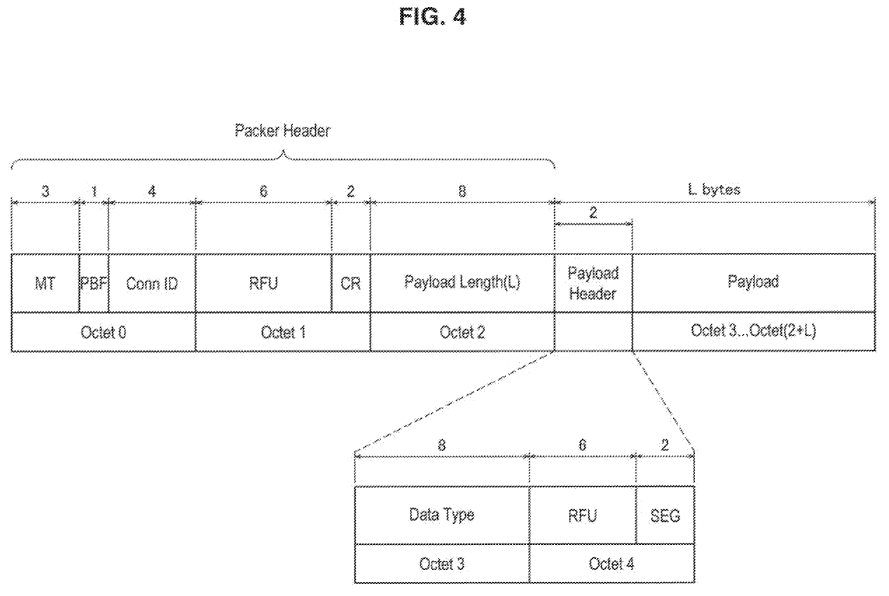

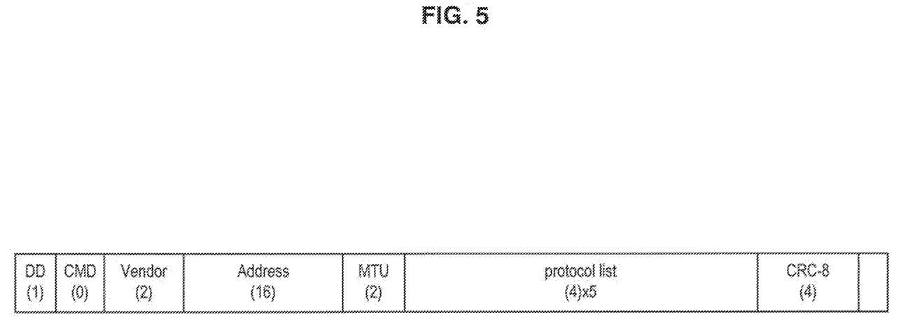

The packet generating unit 132 generates a packet transmitted from the communication unit 150 to the mobile terminal 20. For example, the packet generating unit 132 generates a control packet and a data packet. The packet generating unit 132 according to the present embodiment can generate a negotiation packet for protocol selection also, as a data packet. The negotiation packet includes two or more pieces of protocol information indicating two or more protocols usable by the sensor terminal 10. Herein, priority is assigned to the two or more protocols, and the packet generating unit 132 arranges two or more pieces of protocol information (protocol UUID) in the negotiation packet in a form according to the priority of the respective protocols. Note that the priority set to the respective protocols may be stored in advance in the priority storage unit 140. Hereinafter, an entire configuration of a data packet will be described with reference to FIG. 4 and then the negotiation packet will be specifically described with reference to FIG. 5.

FIG. 4 is an explanatory diagram illustrated to describe an overall configuration of a data packet. As illustrated in FIG. 4, a packet generated by the packet generating unit 132 includes a message type (MT), a packet boundary flag (PBF), a connection identifier (Conn ID), credit (CR), payload length (L), payload header, and payload. The payload header includes data type and segmentation (SEG).

FIG. 5 is an explanatory diagram illustrated to describe a configuration of payload of a negotiation packet. As illustrated in FIG. 5, the payload of the negotiation packet includes DD, CMD, vendor, address, MTU, protocol list, and CRC-8.

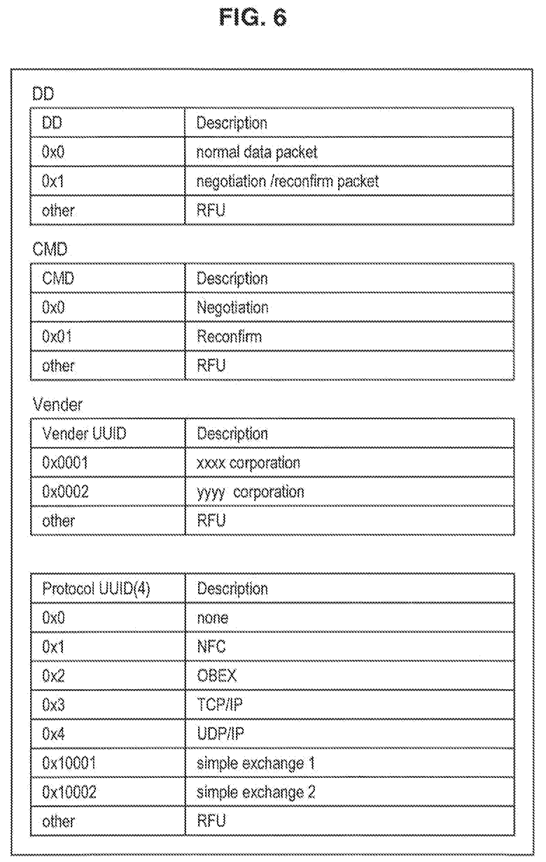

In DD, a value indicating normal data packet or negotiation packet/reconfirm packet described later is set as illustrated in FIG. 6. In CMD, a value indicating negotiation or reconfirm is set as illustrated in FIG. 6. In vendor, a value of manufacturer of a communication device is set as illustrated in FIG. 6.

As for the protocol list, protocol UUIDs are assigned to respective protocols in advance as illustrated in FIG. 6. For example, a protocol UUID “0x1” is assigned to NFC, a protocol UUID “0x2” is assigned to OBEX, a protocol UUID “0x3” is assigned to TCT/IP, a protocol UUID “0x4” is assigned to UDP/IP, a protocol UUID “0x10001” is assigned to simple exchange 1, and a protocol UUID “0x10002” is assigned to simple exchange 2.

The packet generating unit 132 sets a protocol UUID corresponding to protocol information stored in the priority storage unit 140 to a predetermined field, namely, the protocol list. Herein, the packet generating unit 132 may set respective protocol UUIDs to the protocol list in arrangement order according to priority of the respective protocols. For example, the packet generating unit 132 may set a protocol UUID closer to a top as priority of a protocol corresponding to the protocol UUID increases.

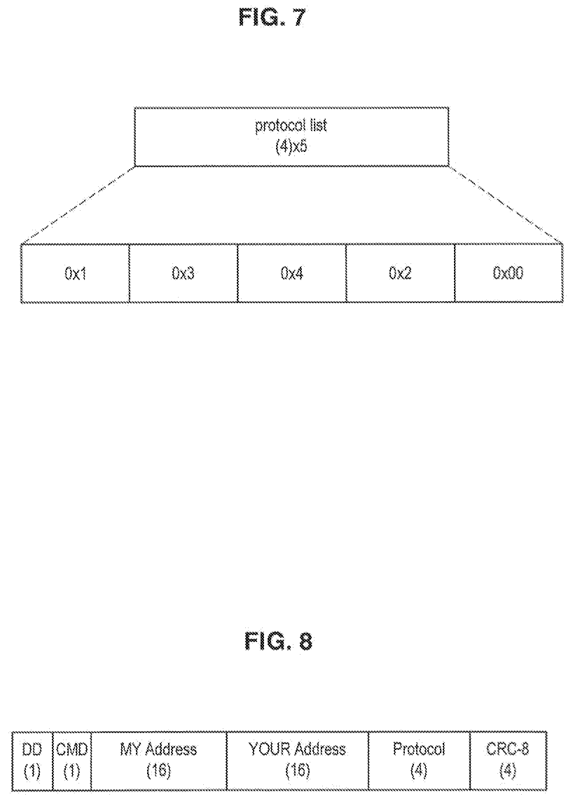

FIG. 7 is an explanatory diagram illustrated to describe a specific example of the protocol list. In an example illustrated in FIG. 7, the protocol UUIDs are set to the protocol list in arrangement order of the protocol UUID “0x1” corresponding to NFC, the protocol UUID “0x3” corresponding to TCP/IP, the protocol UUID “0x4” corresponding to UDP/IP, and the protocol UUID “0x2” corresponding to OBEX. In a case in which a protocol UUID is set closer to the top as priority of a packet corresponding to the protocol UUID increases as described above, the protocol list illustrated in FIG. 7 indicates that NFC corresponding to the protocol UUID “0x1” has highest priority, and TCP/IP corresponding to the protocol UUID “0x3” has second highest priority. By thus setting the protocol UUIDs in arrangement order according to priority instead of adding explicit information indicating priority, an amount of information of the negotiation packet can be reduced. Note that the arrangement order according to priority is not limited to the above example and, for example, as priority of a protocol corresponding to a protocol UUID decreases, the protocol UUID may be set closer to the top.

Moreover, the packet generating unit 132 has a function of generating a reconfirm packet. The reconfirm packet is a packet to notify another communication device of a protocol UUID indicating a protocol selected at previous connection with the other communication device.

FIG. 8 is an explanatory diagram illustrated to describe a configuration example of the reconfirm packet. As illustrated in FIG. 8, the reconfirm packet includes DD, CMD, my address, your address, a protocol, and CRC-8. My address is an address (UUID) of the sensor terminal 10, and your address is an address (UUID) of the other communication device that has been connected before. To protocol, a protocol UUID indicating a protocol selected at previous connection with the other communication device is set. Note that the MAC address of a communication device can be changed at each connection, but the UUID of a communication device is unique and, therefore, the other communication device can be identified uniquely by using the UUID of the communication device as address in the reconfirm packet.

The communication control unit 130 controls communication between the communication unit 150 and the mobile terminal 20 according to a protocol selected by the mobile terminal 20 on the basis of communication of the negotiation packet or the reconfirm packet described above.

### (Communication Unit)

The communication unit 150 has functions of a transmitting unit and a receiving unit, and performs communication with the mobile terminal 20 through a human body according to a control by the communication control unit 130. For example, the communication unit 150 may communicate with the mobile terminal 20 by using a frequency band of 2.4 GHz, and by using binary phase shift keying (BPSK), quadrature phase shift keying (QPSK), or gaussian filtered minimum shift keying (GMSK) as a modulation method.

### 3. CONFIGURATION OF MOBILE TERMINAL

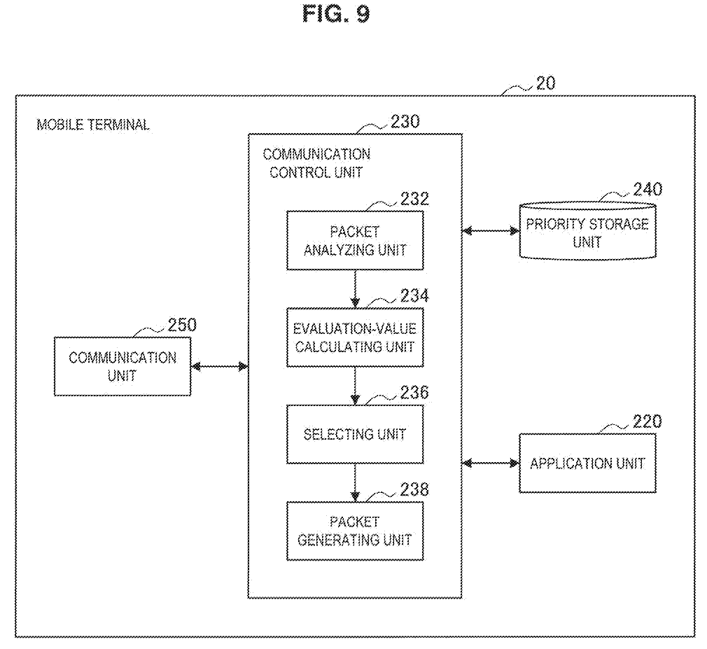

The configuration of the sensor terminal 10 according to the embodiment of the present disclosure has been described above. Subsequently, a configuration of the mobile terminal 20 according to the embodiment of the present disclosure will be described with reference to FIG. 9.

FIG. 9 is a block diagram illustrated to describe a configuration of the mobile terminal 20 according to the embodiment of the present disclosure. As illustrated in FIG. 9, the mobile terminal 20 according to the embodiment of the present disclosure includes an application unit 220, a communication control unit 230, a priority storage unit 240, and a communication unit 250.

### (Application Unit)

The application unit 220 is one, or two or more applications that perform processing using detection information received from the sensor terminal 10. The application unit 220 may include an application for performing, for example, monitoring of health conditions of a user, monitoring of sleep conditions of a user, or monitoring of kinetic conditions of a user.

### (Communication Control Unit, Priority Storage Unit)

The communication control unit 230 controls overall communication of the mobile terminal 20. The priority storage unit 240 stores a protocol list that indicates priority of each of two or more protocols. Particularly in the communication control unit 130 according to the present embodiment, a function of determining a protocol for communication with the sensor terminal 10 after connection of the device host layer with the sensor terminal 10 is established is implemented as the high-level data link layer. Part of the function is implemented by a packet analyzing unit 232, an evaluation-value calculating unit 234, a selecting unit 236, and a packet generating unit 238 illustrated in FIG. 9.

The packet analyzing unit 232 analyzes a packet received by the communication unit 250 from the sensor terminal 10. Particularly, the packet analyzing unit 232 extracts a protocol list in the negotiation packet and priority of each protocol in a case in which the received packet is the negotiation packet. For example, the packet analyzing unit 232 may extract priority of a protocol corresponding to each protocol UUID on the basis of the arrangement order of two or more protocol UUIDs included in the protocol list.

Note that there is a case in which the sensor terminal 10 is designated as talker, and the protocol list included in the negotiation packet received from the sensor terminal 10 is designated as talker-side protocol list in the following. Moreover, there is a case in which the mobile terminal 20 is designated as listener, and the protocol list stored in the priority storage unit 240 is designated as listener-side protocol list.

The evaluation-value calculating unit 234 calculates an evaluation value of each protocol common to the talker-side protocol list and the listener-side protocol list on the basis of priority of each protocol indicated in the talker-side protocol list and priority of each protocol indicated in the listener-side protocol list. For example, the evaluation-value calculating unit 234 may calculate a mean value of the priority in the talker-side protocol list and the priority in the listener-side protocol list as an evaluation value. A specific example of evaluation value calculation will be described.

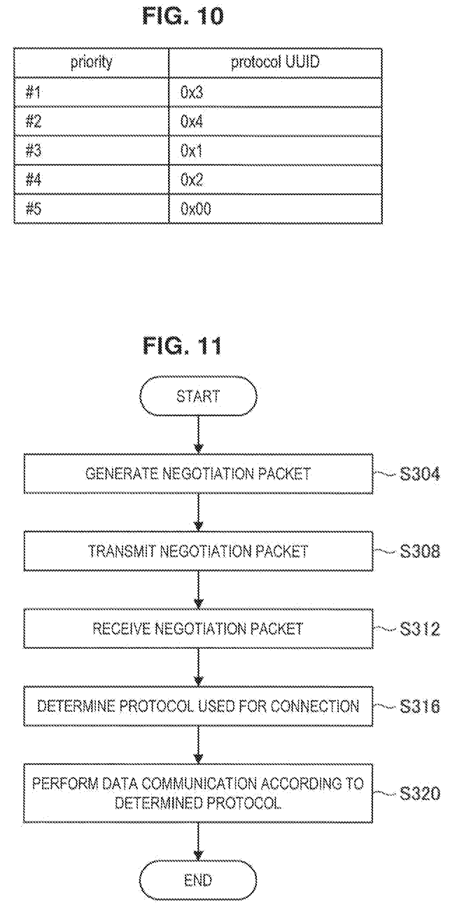

FIG. 10 is an explanatory diagram illustrated to describe a specific example of a listener-side protocol list. In an example illustrated in FIG. 10, priority of TCP/IP corresponding to the protocol UUID “0x3” is “1” and is the highest, and priority of UDP/IP corresponding to the protocol UUID “0x4” is “2” and is the second highest. Furthermore, the talker-side protocol list is the protocol list illustrated in FIG. 7, and in a case in which the evaluation value is calculated as a mean value described above, the evaluation-value calculating unit 234 calculates “1.5” as an evaluation value of the TCP/IP corresponding to the protocol UUID “0x3”. Similarly, the evaluation-value calculating unit 234 calculates “2” as an evaluation value of NFC corresponding to the protocol UUID “0x1”, calculates “2.5” as an evaluation value of UDP/IP corresponding to the protocol UUID “0x4”, and calculates “4” as an evaluation value of OBEX corresponding to the protocol UUID “0x2”.

Note that the calculation method of an evaluation value described above is only an example, and the evaluation-value calculating unit 234 may calculate an evaluation value of respective protocols by another method. For example, the evaluation-value calculating unit 234 may calculate an evaluation value by weighted average, or may calculate (specify) higher priority or lower priority between priority in the listener-side priority list and priority in the talker-side protocol list as an evaluation value.

Furthermore, the listener-side protocol list may be fixed or may vary dynamically. For example, the listener-side protocol list may be set per application, and in this case, the evaluation-value calculating unit 234 may use a listener-side protocol list according to an application operating in the application unit 220.

The selecting unit 236 selects a protocol, the evaluation value of which calculated by the evaluation-value calculating unit 234 is the highest from protocols common to the listener-side protocol list and the talker-side protocol list. For example, in a calculation result of evaluation values described with reference to FIG. 10, the evaluation value “1.5” of TCP/IP corresponding to the protocol UUID “0x3” is the highest and, therefore, the selecting unit 236 selects TCP/IP.

As described, the selecting unit 236 can select an appropriate protocol from two or more protocols common to the sensor terminal 10 and the mobile terminal 20 by using the evaluation values calculated based on priority set to respective protocols. Moreover, in the present embodiment, one of two or more protocols usable by the sensor terminal 10 is indicated by the negotiation packet and, therefore, the number of going back and forth in negotiation is reduced, and prompt protocol selection can be achieved.

Note that in a case in which plurality of protocols, the evaluation value of which is the highest are present, the selecting unit 236 may select a protocol having higher priority in the listener-side protocol list among the plurality of protocols. Alternatively, the selecting unit 236 may select a protocol having higher priority in the talker-side protocol list among the plurality of protocols.

The packet generating unit 238 generates a packet transmitted from the communication unit 250 to the sensor terminal 10. For example, the packet generating unit 238 generates a control packet and a data packet. The packet generating unit 238 according to the present embodiment can generate a negotiation packet that indicates a result of protocol selection also, as a data packet. That is, the packet generating unit 238 may generate a negotiation packet that indicates a protocol selected by the selecting unit 236.

### (Communication Unit)

The communication unit 250 has functions of a transmitting unit and a receiving unit, and communicates with the sensor terminal 10 through a human body according to a control by the communication control unit 230. For example, the communication unit 250 may communicate with the sensor terminal 10 by using a frequency band of 2.4 GHz, and by using BPSK, QPSK, or GMSK as a modulation method.

### 4. ACTION

The configurations of the sensor terminal 10 and the mobile terminal 20 according to the embodiment of the present disclosure have been described above. Subsequently, actions of the sensor terminal 10 and the mobile terminal 20 according to the embodiment of the present disclosure will be summarized with reference to FIG. 11 to FIG. 13.

### (Action of Sensor Terminal)

FIG. 11 is a flowchart illustrated to describe an action of the sensor terminal 10 according to the embodiment of the present disclosure. As illustrated in FIG. 11, first, the packet generating unit 132 sets respective protocol UUIDs to the protocol list in arrangement order according to priority of respective protocols, and generates a negotiation packet including the protocol list (S304). The communication unit 150 then transmits the negotiation packet generated by the packet generating unit 132 to the mobile terminal 20 (S308).

Thereafter, when the communication unit 150 receives the negotiation packet indicating a result of protocol selection from the mobile terminal 20 (step S312), the communication control unit 230 determines the protocol indicated in the received negotiation packet as the protocol to be used for connection (S316). Furthermore, the communication control unit 230 performs data communication with the mobile terminal 20 according to the determined protocol (S320).

### (Action of Mobile Terminal)

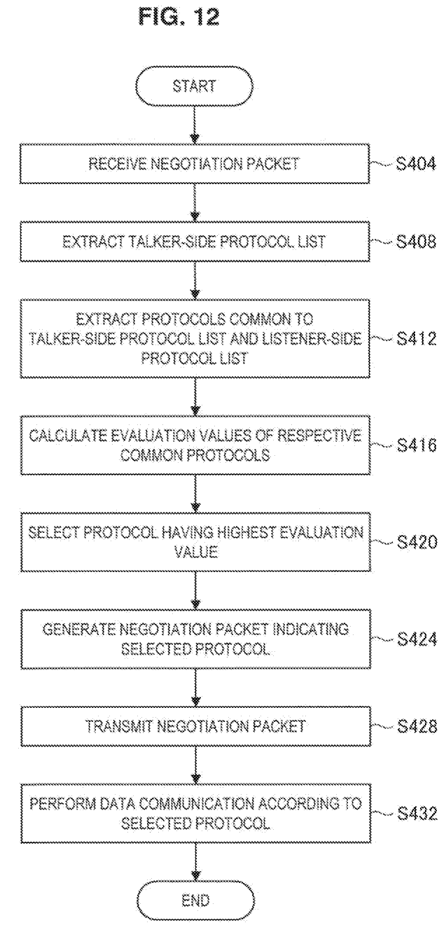

FIG. 12 is a flowchart illustrated to describe an action of the mobile terminal 20 according to the embodiment of the present disclosure. First, when the communication unit 250 receives the negotiation packet from the sensor terminal 10 (step S404), the packet analyzing unit 232 extracts the talker-side protocol list and priority of respective protocols from the negotiation packet (S408).

Furthermore, the evaluation-value calculating unit 234 extracts a common protocol to the talker-side protocol list and the listener-side protocol list, and calculates an evaluation value of the common protocol on the basis of priority of respective protocols indicated in the talker-side protocol list and priority of respective protocols indicated in the listener-side protocol list (S412, S416).

Subsequently, the selecting unit 236 selects a protocol, the evaluation value calculated by the evaluation-value calculating unit 234 of which is the highest from the protocols common to the listener-side protocol list and the talker-side protocol list (S420). Thereafter, the packet generating unit 238 generates a negotiation packet indicating the protocol selected by the selecting unit 236 (S424).

The communication unit 250 then transmits the negotiation packet generated by the packet generating unit 238 to the sensor terminal 10 (S428), and communication control unit 230 performs data communication with the sensor terminal 10 according to the protocol selected by the selecting unit 236 (S432).

### (Communication Sequence)

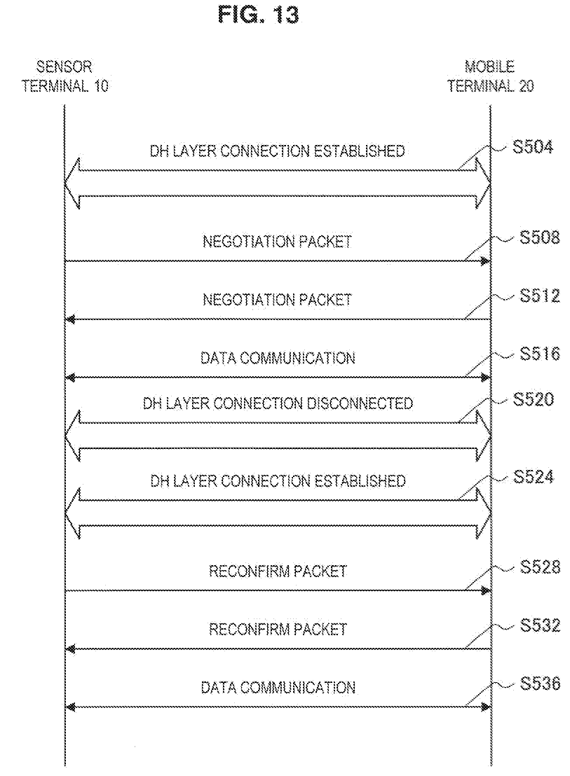

FIG. 13 is an explanatory diagram illustrated to describe a communication sequence between the sensor terminal 10 and the mobile terminal 20 according to the embodiment of the present disclosure. As illustrated in FIG. 13, after connection of the device host layer is established between the sensor terminal 10 and the mobile terminal 20 (S504), the sensor terminal 10 and the mobile terminal 20 exchange the negotiation packets (SS508, S512). Subsequently, the sensor terminal 10 and the mobile terminal 20 perform data communication according to a protocol selected by the exchange of the negotiation packets (S516).

Thereafter, when the connection of the device host layer is disconnected between the sensor terminal 10 and the mobile terminal 20 due to a situation in which the mobile terminal 20 communicates with another device or the like (S520), and then connection of the device host layer is again established (S524), the sensor terminal 10 transmits the reconfirm packet described with reference to FIG. 8 (S528).

In a case in which the UUID indicated in the received reconfirm packet coincides with the UUID of the mobile terminal 20, the mobile terminal 20 transmits a reconfirm packet indicating use of the protocol included in the received reconfirm packet to the sensor terminal 10 (S532). Thereafter, the sensor terminal 10 and the mobile terminal 20 perform data communication according to the protocol that has been determined to be used by the exchange of the reconfirm packets (S536).

Note that use of the reconfirm packet is not essential, but the sensor terminal 10 and the mobile terminal 20 may exchange negotiation packets each time connection of the device host layer is established, and perform protocol selection on the basis of the negotiation packets.

### 5. MODIFICATION

The embodiment of the present disclosure has been described above. Hereinafter, some modifications of the embodiment of the present disclosure will be described. Note that the respective modifications described below may be applied to the embodiment of the present disclosure alone, or may be applied to the embodiment of the present disclosure in combination. Moreover, the respective modifications may be applied in place of the configuration described in the embodiment of the present disclosure, or may be applied additionally to the configuration described in the embodiment of the present disclosure.

### (First Modification)

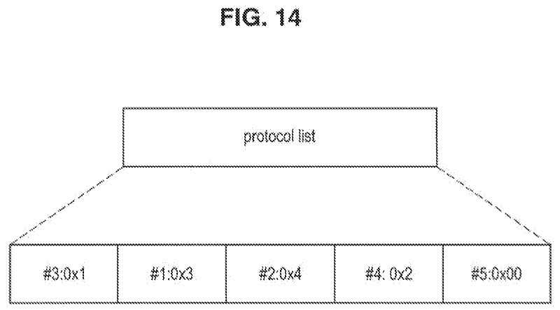

In the above description, an example in which priority of each protocol is indicated by arrangement order of protocol UUIDs has been described, but the priority of each protocol can be indicated by another method also. For example, as illustrated in FIG. 14, information indicating priority explicitly may be associated with each protocol UUID. In this case, the mobile terminal 20 can recognize priority of each protocol on the basis of the information indicating priority.

### (Second Modification)

In the above description, an example in which the sensor terminal 10 transmits a protocol list including plurality of protocol UUIDs has been described, but the form of transmission of the protocol UUIDs is not limited this example. For example, the sensor terminal 10 may transmit respective protocol UUIDs in transmission order according to priority of respective protocols, or may transmit information indicating priority in addition to respective protocol UUIDs.

### (Third Modification)

In the above description, an example in which the mobile terminal 20 performs protocol selection as a listener side has been described, but the sensor terminal 10 may receive a protocol list from the mobile terminal 20, and the sensor terminal 10 may perform the protocol selection as a listener side. Moreover, the sensor terminal 10 and the mobile terminal 20 may have both the function of a talker and the function of a listener described above.

### (Fourth Modification)

In the above description, an example in which the selecting unit 236 performs protocol selection on the basis of priority of respective protocols in both the sensor terminal 10 and the mobile terminal 20 has been described, but another protocol selection method can be implementable. For example, the selecting unit 236 may perform protocol selection by using only one out of priority of respective protocols indicated in the protocol list received from the sensor terminal 10 and priority of respective protocols indicated in the protocol list from the mobile terminal 20. With this configuration also, the selecting unit 236 can select a protocol from two or more protocols common to the sensor terminal 10 and the mobile terminal 20.

### (Fifth Modification)

In the above description, OBEX, SCSI, TCP/IP, and the like have been described as an example of plurality of protocols, but the embodiment of the present disclosure is applicable to any other protocol. Furthermore, variations in profile, service, and characteristic, and variations in key in Bluetooth (registered trademark) can also be regarded as variations of protocols.

### 6. HARDWARE CONFIGURATION

The embodiment of the present disclosure has been described above. The information processing such as packet analysis and protocol selection described above is implemented by cooperation between software and hardware of the mobile terminal 20 described below.

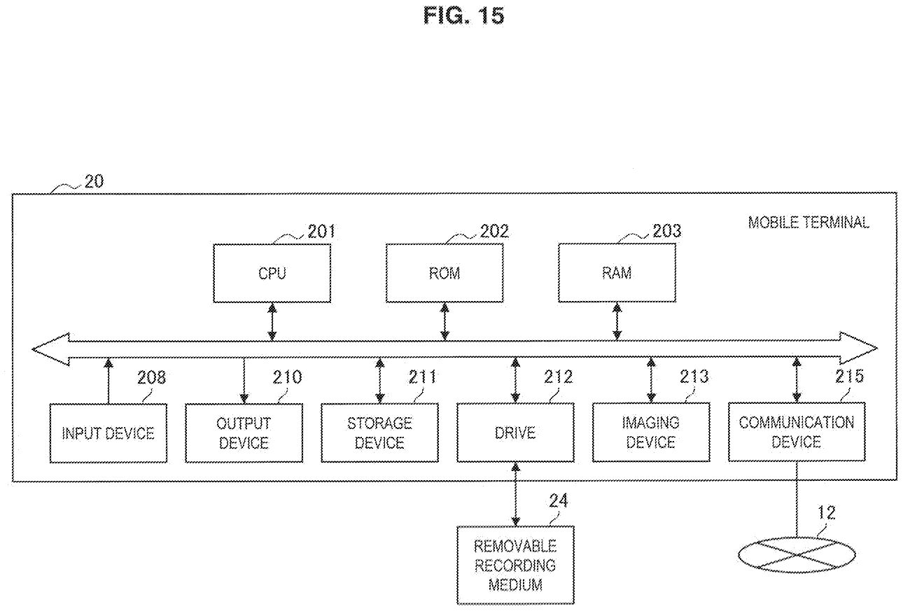

FIG. 15 is a diagram illustrated to describe the hardware configuration of the mobile terminal 20. As illustrated in FIG. 15, the mobile terminal 20 includes a central processing unit (CPU) 201, a read only memory (ROM) 202, a random access memory (RAM) 203, an input device 208, an output device 210, a storage device 211, a drive 212, an imaging device 213, and a communication device 215.

The CPU 201 functions as an operation processing device and a control device, and controls all the operations within the mobile terminal 20 in accordance with various programs. In addition, the CPU 201 can be a microprocessor. The ROM 202 stores programs and operation parameters used by the CPU 201. The RAM 203 temporarily stores programs used in the execution of the CPU 201 or stores parameters or the like that are appropriately changed in the execution thereof. These components are mutually connected through a host bus including a CPU bus or the like. The cooperation of the CPU 201, the ROM 202, and the RAM 203 with software makes it possible to implement of each of the functions of the communication control unit 230 of the mobile terminal 20.

The input device 208 includes an input means, an input control circuit, or the like. The input means is used for a user to input information, such as a mouse, a keyboard, a touch panel, a button, a microphone, a switch, or a lever. The input control circuit generates an input signal on the basis of an input by the user and outputs it to the CPU 201. The user of the mobile terminal 20 is capable of operating the input device 208 to input various data to the mobile terminal 20 or to instruct it to perform processing operations.

The output device 210 includes, in one example, a display device, such as a liquid crystal display (LCD) device, an organic light emitting diode (OLED) device, or a lamp. Furthermore, the output device 210 includes a sound output device, such as a speaker or a headphone. In one example, the display device displays a captured image or a generated image. On the other hand, the sound output device converts speech data or the like into sound and outputs it.

The storage device 211 is a device for data storage constituted as an example of a storage unit of the mobile terminal 20 according to the present embodiment. The storage device 211 can include a storage medium, a recording device that records data to the storage medium, a reading device that reads data from the storage medium, and an erasure device that erases data recorded in the storage medium. This storage device 211 stores programs executed by the CPU 201 and various data.

The drive 212 is a reader-writer for the storage medium, and is built into the mobile terminal 20 or is externally attached thereto. The drive 212 reads information recorded on a removable storage medium 24, such as a mounted magnetic disk, optical disk, magneto-optical disk, or semiconductor memory, and outputs it to the RAM 203. In addition, the drive 212 is also capable of writing information to the removable storage medium 24.

The imaging device 213 includes an imaging optical system such as a photographic lens for focusing light and a zoom lens, and a signal conversion device such as a charge coupled device (CCD) and a complementary metal oxide semiconductor (CMOS). The imaging optical system focuses light originating from a subject to form a subject image on a signal converting portion, and the signal conversion device converts the formed subject image into an electrical image signal.

The communication device 215 is, in one example, a communication interface constituted by a communication device or the like for connecting to the communication network 12. In addition, the communication device 215 can be a wireless local area network (LAN) compatible communication device, a long-term evolution (LTE) compatible communication device, or a wired communication device that performs wired communication. Moreover, the communication device 215 according to the embodiment of the present disclosure is also compatible with communication using a human body as a transmission medium described with reference to FIG. 9.

Note that the functions of the sensor terminal 10 can also be implemented similarly by cooperation of hardware including a CPU, a ROM, a RAM, and the like, and software.

### 7. CONCLUSION

As described above, according to the embodiment of the present disclosure, it is possible to select an appropriate protocol from two or more protocols common to the sensor terminal 10 and the mobile terminal 20 on the basis of priority set to respective protocols. That is, it is possible to ease complexity for users in protocol selection, and to perform appropriate protocol selection.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

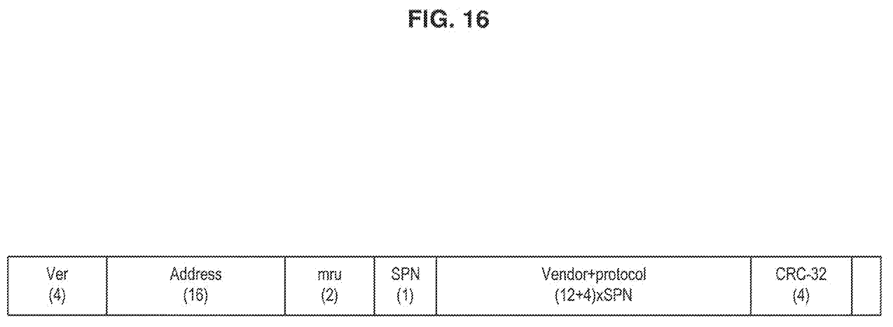

For example, the configuration of the negotiation packet is not limited to the configuration described with reference to FIG. 5 and the like, but may be of another configuration. FIG. 16 is an explanatory diagram illustrated to describe another configuration example of the negotiation packet. As illustrated in FIG. 16, the negotiation packet may include ver, address, mru, SPN, protocol list (vender+protocol), and CRC-32. Ver is version information, mru indicates a reception buffer size corresponding to a transmission source terminal of the negotiation packet, and SPN indicates a support protocol number.

A protocol list in the example illustrated in FIG. 16 is constituted of a combination of vender and protocol UUID. The selecting unit 236 of the mobile terminal 20 may select a protocol having the highest evaluation value calculated by the evaluation-value calculating unit 234 from combinations of vender and protocol UUID common to the listener-side protocol list and the talker-side protocol list. Furthermore, the packet generating unit 238 may generate a negotiation packet that includes combinations of vender and protocol UUID common to the listener-side protocol list and the talker-side protocol list. In the negotiation packet, ranking of evaluation values calculated by the evaluation-value calculating unit 234 may be indicated, or ranking of priority in the listener-side protocol list may be indicated.

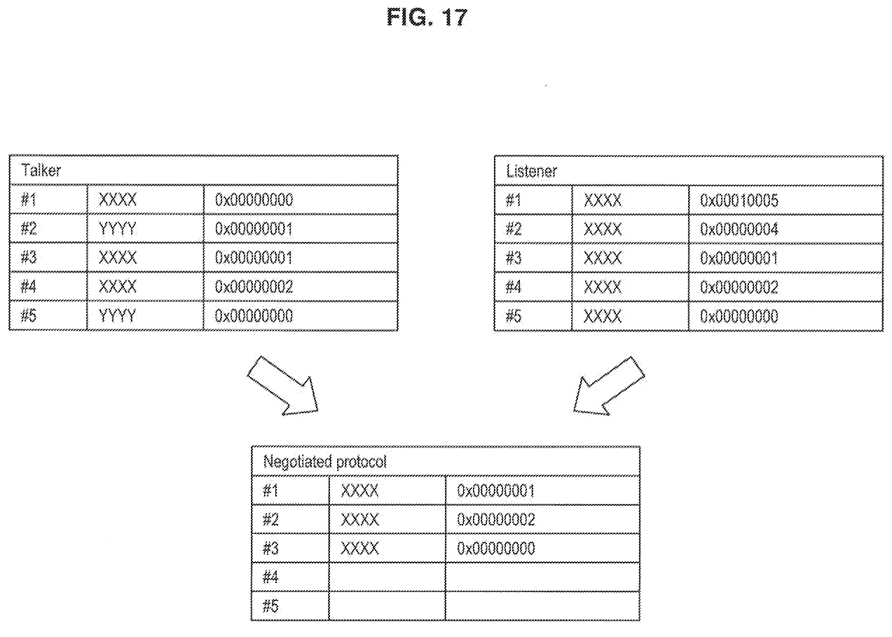

FIG. 17 is an explanatory diagram illustrated to describe a specific example of protocol selection. In the listener-side protocol list illustrated in an upper part of FIG. 17, vender “XXXX” and protocol UUIDs “0x00000001” to “0x00000002” are common to the listener-side protocol list and the talker-side protocol list. Therefore, the packet generating unit 238 generates a negotiation packet that includes a combination of verder “XXXX” and protocol UUIDs “0x00000001” to “0x00000002” as illustrated in a lower part of FIG. 17, and the communication unit 250 transmits the negotiation packet to the sensor terminal 10. The sensor terminal 10 can determine a protocol to be used on the basis of reception of the negotiation packet.

Moreover, respective steps in the processing of the sensor terminal 10 or the mobile terminal 20 of the present application are not necessarily required to be performed chronologically according to the order described as a sequence diagram or a flowchart. For example, the respective steps in the processing of the sensor terminal 10 or the mobile terminal 20 may be processed in different order from the order described as a flowchart, or processed in parallel.

Furthermore, a computer program that causes hardware, such as a CPU, a ROM, and a RAM, mounted on the sensor terminal 10 or the mobile terminal 20 to exert functions equivalent to the respective components of the sensor terminal 10 or the mobile terminal 20 described above may also be created. Moreover, a storage medium in which the computer program is stored is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A communication device including:

a receiving unit that receives two or more pieces of protocol information, each of which indicates a protocol, from another communication device;

a selecting unit that selects a protocol on the basis of priority set for protocol selection from protocols common to two or more protocols usable by the communication device and two or more protocols indicated by the two or more pieces of protocol information; and

a communication control unit that controls communication with the other communication device according to the protocol selected by the selecting unit.

(2)

The communication device according to (1), further including: an analyzing unit that analyzes information received from the other communication device, and that extracts priority of respective protocols indicated by the two or more pieces of protocol information,

in which the selecting unit selects the protocol on the basis of the priority extracted by the analyzing unit as the priority set for the protocol selection.

(3)

The communication device according to (2),

in which the two or more pieces of protocol information are arranged in a predetermined field in a packet, and

the analyzing unit extracts the priority of the respective protocols on the basis of arrangement order of the two or more pieces of protocol information in the field.

(4)

The communication device according to (2),

in which the analyzing unit extracts the priority of the respective protocols from priority information transmitted in association with each of the two or more pieces of protocol information.

(5)

The communication device according to any one of (1) to (3), further including:

a storage unit that stores priority information indicating priority of each of the two or more protocols usable by the communication device,

in which the selecting unit selects the protocol on the basis of the priority information stored in the storage unit as the priority set for the protocol selection.

(6)

The communication device according to (1), further including:

an analyzing unit that analyzes information received from the other communication device, and that extracts priority of respective protocols indicated by the two or more pieces of protocol information; and

a storage unit that stores priority information indicating priority of each of the two or more protocols usable by the communication device,

in which the selecting unit selects the protocol on the basis of both the priority extracted by the analyzing unit and the priority information stored in the storage unit.

(7)

The communication device according to (6), further including:

an evaluation-value calculating unit that calculates, for each of protocols, an evaluation value on the basis of both the priority extracted by the analyzing unit and the priority indicated by the priority information stored in the storage unit,

in which the selecting unit selects the protocol, the evaluation value of which is highest, the evaluation value being calculated for each of the protocols.

(8)

The communication device according to (7),

in which in a case in which a plurality of protocols, the evaluation value of which is highest, are present, the selecting unit selects a protocol, the priority of which is higher, the priority being indicated by the priority information stored in the storage unit.

(9)

The communication device according to any one of (1) to (8),

in which in a case in which a packet including protocol information indicating a protocol that has been selected at previous connection with the other communication device is received from the other communication device, the selecting unit selects a protocol indicated by the protocol information included in the packet.

(10)

A communication device including:

a transmitting unit that transmits two or more pieces of protocol information, each of which indicates a protocol, to another communication device;

a receiving unit that receives selected protocol information indicating a protocol that has been selected from two or more protocols indicated by the two or more pieces of protocol information on the basis of priority set for protocol selection from the other communication device; and

a communication control unit that controls communication with the other communication device according to the protocol indicated by the selected protocol information received by the receiving unit.

(11)

The communication device according to (10), further including:

a packet generating unit that generates a packet including the two or more pieces of protocol information,

in which the packet generating unit arranges the two or more pieces of protocol information in a predetermined field included in the packet in order according to priority set to the two or more pieces of protocol information.

(12)

The communication device according to (10), further including:

a packet generating unit that generates a packet including priority information associated with each of the two or more pieces of protocol information.

(13)

The communication device according to any one of (10) to (12),

in which the transmitting unit transmits a packet including protocol information indicating a protocol that has been used at previous connection with the other communication device and identification information of the other communication device.

(14)

A communication method including:

receiving, by a communication device, two or more pieces of protocol information, each of which indicates a protocol, from another communication device;

selecting, by a processor, a protocol on the basis of priority set for protocol selection from protocols common to two or more protocols usable by the communication device and two or more protocols indicated by the two or more pieces of protocol information; and

controlling communication with the other communication device according to the selected protocol.

(15)

A communication method including:

transmitting, by a communication device, two or more pieces of protocol information, each of which indicates a protocol, to another communication device;

receiving selected protocol information indicating a protocol that has been selected from two or more protocols indicated by the two or more pieces of protocol information on the basis of priority set for protocol selection from the other communication device; and

controlling, by a processor, communication with the other communication device according to the protocol indicated by the received selected protocol information.

(16)

A program that causes a computer to function as a communication device including:

a receiving unit that receives two or more pieces of protocol information, each of which indicates a protocol, from another communication device;

a selecting unit that selects a protocol on the basis of priority set for protocol selection from protocols common to two or more protocols usable by the communication device and two or more protocols indicated by the two or more pieces of protocol information; and

a communication control unit that controls communication with the other communication device according to the protocol selected by the selecting unit.

(17)

A program that causes a computer to function as:

a transmitting unit that transmits two or more pieces of protocol information, each of which indicates a protocol, to another communication device;

a receiving unit that receives selected protocol information indicating a protocol that has been selected from two or more protocols indicated by the two or more pieces of protocol information on the basis of priority set for protocol selection from the other communication device; and

a communication control unit that controls communication with the other communication device according to the protocol indicated by the selected protocol information received by the receiving unit.

(18)

A communication system including:

a first communication device that transmits two or more pieces of protocol information, each of which indicates a protocol; and

a second communication device,

in which the second communication device includes

a receiving unit that receives the two or more pieces of protocol information from the first communication device,

a selecting unit that selects a protocol on the basis of priority set for protocol selection from protocols common to two or more protocols usable by the first communication device and two or more protocols indicated by the two or more pieces of protocol information, and

a communication control unit that controls communication with the first communication device according to the protocol selected by the selecting unit.

### REFERENCE SIGNS LIST

10 sensor terminal
20 mobile terminal
120 sensor unit
130 communication control unit
132 packet generating unit
140 priority storage unit
150 communication unit
220 application unit
230 communication control unit
232 packet analyzing unit
234 evaluation-value calculating unit
236 selecting unit
238 packet generating unit
240 priority storage unit
250 communication unit

1. A communication device comprising:
a receiving unit that receives two or more pieces of protocol information, each of which indicates a protocol, from another communication device;
a selecting unit that selects a protocol on a basis of priority set for protocol selection from protocols common to two or more protocols usable by the communication device and two or more protocols indicated by the two or more pieces of protocol information; and
a communication control unit that controls communication with the other communication device according to the protocol selected by the selecting unit.

2. The communication device according to claim 1, further comprising:
an analyzing unit that analyzes information received from the other communication device, and that extracts priority of respective protocols indicated by the two or more pieces of protocol information,
wherein the selecting unit selects the protocol on a basis of the priority extracted by the analyzing unit as the priority set for the protocol selection.

3. The communication device according to claim 2,
wherein the two or more pieces of protocol information are arranged in a predetermined field in a packet, and
the analyzing unit extracts the priority of the respective protocols on a basis of arrangement order of the two or more pieces of protocol information in the field.

4. The communication device according to claim 2,
wherein the analyzing unit extracts the priority of the respective protocols from priority information transmitted in association with each of the two or more pieces of protocol information.

5. The communication device according to claim 1, further comprising:
a storage unit that stores priority information indicating priority of each of the two or more protocols usable by the communication device,
wherein the selecting unit selects the protocol on a basis of the priority information stored in the storage unit as the priority set for the protocol selection.

6. The communication device according to claim 1, further comprising:
an analyzing unit that analyzes information received from the other communication device, and that extracts priority of respective protocols indicated by the two or more pieces of protocol information; and
a storage unit that stores priority information indicating priority of each of the two or more protocols usable by the communication device,
wherein the selecting unit selects the protocol on a basis of both the priority extracted by the analyzing unit and the priority information stored in the storage unit.

7. The communication device according to claim 6, further comprising:
an evaluation-value calculating unit that calculates, for each of protocols, an evaluation value on a basis of both the priority extracted by the analyzing unit and the priority indicated by the priority information stored in the storage unit,
wherein the selecting unit selects the protocol, the evaluation value of which is highest, the evaluation value being calculated for each of the protocols.

8. The communication device according to claim 7,
wherein in a case in which a plurality of protocols, the evaluation value of which is highest, are present, the selecting unit selects a protocol, the priority of which is higher, the priority being indicated by the priority information stored in the storage unit.

9. The communication device according to claim 1,
wherein in a case in which a packet including protocol information indicating a protocol that has been selected at previous connection with the other communication device is received from the other communication device, the selecting unit selects a protocol indicated by the protocol information included in the packet.

10. A communication device comprising:
a transmitting unit that transmits two or more pieces of protocol information, each of which indicates a protocol, to another communication device;
a receiving unit that receives selected protocol information indicating a protocol that has been selected from two or more protocols indicated by the two or more pieces of protocol information on a basis of priority set for protocol selection from the other communication device; and
a communication control unit that controls communication with the other communication device according to the protocol indicated by the selected protocol information received by the receiving unit.

11. The communication device according to claim 10, further comprising:
a packet generating unit that generates a packet including the two or more pieces of protocol information,
wherein the packet generating unit arranges the two or more pieces of protocol information in a predetermined field included in the packet in order according to priority set to the two or more pieces of protocol information.

12. The communication device according to claim 10, further comprising:
a packet generating unit that generates a packet including priority information associated with each of the two or more pieces of protocol information.

13. The communication device according to claim 10,
wherein the transmitting unit transmits a packet including protocol information indicating a protocol that has been used at previous connection with the other communication device and identification information of the other communication device.

14. A communication method comprising:
receiving, by a communication device, two or more pieces of protocol information, each of which indicates a protocol, from another communication device;
selecting, by a processor, a protocol on a basis of priority set for protocol selection from protocols common to two or more protocols usable by the communication device and two or more protocols indicated by the two or more pieces of protocol information; and
controlling communication with the other communication device according to the selected protocol.

15. A communication method comprising:
transmitting, by a communication device, two or more pieces of protocol information, each of which indicates a protocol, to another communication device;
receiving selected protocol information indicating a protocol that has been selected from two or more protocols indicated by the two or more pieces of protocol information on a basis of priority set for protocol selection from the other communication device; and
controlling, by a processor, communication with the other communication device according to the protocol indicated by the received selected protocol information.

16. A program that causes a computer to function as a communication device comprising:
a receiving unit that receives two or more pieces of protocol information, each of which indicates a protocol, from another communication device;
a selecting unit that selects a protocol on a basis of priority set for protocol selection from protocols common to two or more protocols usable by the communication device and two or more protocols indicated by the two or more pieces of protocol information; and
a communication control unit that controls communication with the other communication device according to the protocol selected by the selecting unit.

17. A program that causes a computer to function as:
a transmitting unit that transmits two or more pieces of protocol information, each of which indicates a protocol, to another communication device;
a receiving unit that receives selected protocol information indicating a protocol that has been selected from two or more protocols indicated by the two or more pieces of protocol information on a basis of priority set for protocol selection from the other communication device; and
a communication control unit that controls communication with the other communication device according to the protocol indicated by the selected protocol information received by the receiving unit.

18. A communication system comprising:
a first communication device that transmits two or more pieces of protocol information, each of which indicates a protocol; and
a second communication device,
wherein the second communication device includes
a receiving unit that receives the two or more pieces of protocol information from the first communication device,
a selecting unit that selects a protocol on a basis of priority set for protocol selection from protocols common to two or more protocols usable by the first communication device and two or more protocols indicated by the two or more pieces of protocol information, and
a communication control unit that controls communication with the first communication device according to the protocol selected by the selecting unit.
